(19) United States
(12) Patent Application Publication
(10) Pub. No.: US 2007/0209416 A1
(43) Pub. Date: Sep. 13, 2007

(54) Exchangeable Lock Construction

(76) Inventor: Jung Kyu Kim, Taegu (KR)

Correspondence Address: PARK LAW FIRM, 3255 WILSHIRE BLVD, SUITE 1110, LOS ANGELES, CA, 90010, US

(21) Appl. No.: 11/683,961

(22) Filed: Mar. 8, 2007

(30) Foreign Application Priority Data
Mar. 9, 2006 (KR) 20-2006-0006359

(51) Int. Cl. E05B 9/04

(52) U.S. Cl. 70/371

(57) ABSTRACT

Disclosed is an exchangeable lock structure, which is mounted to a door lock of an entrance door of a guest room in accommodations such as a hotel, and the like, and operated by the insertion of a key, and more particularly, it can be detached from or assembled to a main body of the door lock in itself. Concretely, the exchangeable lock structure includes an opening and closing operation portion 10 disposed at a lower portion of a main body 2 and an exchange operation portion 20 at an upper portion thereof. The exchangeable lock structure comprises an operation pin 12 formed with an inclination surface 12-1 and an inclination portion 12-2 at upper and lower ends thereof; an operation space portion 2-1 formed at the inside of the main body 2 adjacent to the upper end of the operation pin 12; an elevation pin 13 inserted into a connection portion between the opening and closing operation portion 10 and the exchange operation portion 20; and an operation slide 21 disposed at an upper portion of the elevation pin 13 so that it is moved while producing frictions with the inclination portion 13-1 when the elevation pin 13 is ascended.

### CLAIMING FOREIGN PRIORITY

The applicant claims and requests a foreign priority, through the Paris Convention for the Protection of Industrial Property, based on patent applications filed in the Republic of Korea (South Korea) with the filing date of Mar. 9, 2006 with the patent application number 20-2006-0006359 by the applicant, the contents of which are incorporated by reference into this disclosure as if fully set forth herein.

### BACKGROUND OF THE INVENTION

1. Field of the Invention

The invention relates to a lock structure which is mounted to a door lock of an entrance door of a guest room in accommodations such as a hotel and the like, and is operated by the insertion of a key, and more particularly, to an exchangeable lock structure, in which the lock structure itself can be detached from or assembled to a main body of the door lock.

2. Background of the Related Art

In general, when a guest lodges at an accommodation such as a hotel, the guest principally leaves a key for his or her room in a front of the hotel when he or she goes out of the hotel. However, if the guest makes up his mind, he or she can go out to the outside with the key of the door lock in the entrance door of the guest room during the lodging, and copy it, so he or she can commit crimes by opening the entrance door with the key previously copied, when he or she lodges at the hotel later.

As a result, several measures have been devised to previously prevent such crimes, and one among them is to mount a detachable door lock to the entrance door of the guest room, and exchange the lock structure of any one door lock of the guest room with another lock structure of the door lock mounted to the other entrance door of the guest room.

In FIG. 1, there has been disclosed a conventional structure for mounting or detaching a lock structure 1a to a door lock, in which an operation slide 2a is provided at one upper side of the lock structure to project in one direction, a retaining pin 4a is disposed therein to control the rearward progress into a hole 3a formed at the operation slide 2a, a connection pin 5a is disposed to push the retaining pin 4a out and operating the operation slide 2a at the time of the rearward progression, an operation pin 7a is inserted into a rotary operation member 6a to push the connection pin 5a upwardly, and a connection ring 8a is rotated by the operation pin 7a and turn over the connection pin 5a. In this regard, an exchange key is also disclosed for detaching and mounting the lock structure.

However, according to such a conventional lock structure as described above, the whole structure was substantially complicated, and the connection pin 5a can be activated by rotation only when the operation pin 7a is elevated by the exchange key to thereby rotate the connection ring 8a, if it is required to activate the operation slide 2a. Thus, the operation slide 2a can move only by upwardly pushing the retaining pin 4a together with the elevation of the connection pin 5a, resulting in a problem that the operation is very complex.

Accordingly, in the conventional lock structure, there is caused a serious problem of obstructing the reliability of the exchangeable lock structure that the production cost is high and the structure is complicated to thereby cause lots of troubles, and produce incomplete operation.

### SUMMARY OF THE INVENTION

Therefore, the present invention has been made in an effort to solve the above-mentioned problems occurring in the prior art and to produce improved effect by combining advantages thereof, and an object of the present invention is to provide an exchangeable lock structure, which improves the construction of an operating main body type lock structure detachable from the door lock, to thereby reduce the manufacturing cost and promote smooth activation and fault prevention, resulting in the improvement of the reliability of the exchangeable lock structure.

To achieve above object of the present invention, the exchangeable lock structure of the present invention is characterized by comprising an operation pin having an inclination surface for pushing up an elevation pin at the time of the rotation and is ascended by the insertion of an exchange special key, an elevation pin for moving an operation slide in the rearward direction by using the inclination surface together with ascending along the inclination surface by the rotation of the operation pin, and an operation slide moving in the rearward direction together with compressing a spring by the ascending of the elevation pin to thereby enable the separation of the lock structure, and characterized in that the construction is improved so that a serious of operations followed by the insertion and rotation of the key can be accomplished through very simple construction and easy operation.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a cross-sectional view showing a conventional lock structure;

FIG. 2 is a cross-sectional view showing a lock structure of the present invention, in which an exchange key has not yet been inserted;

FIG. 3 is a cross-sectional view showing a lock structure of the present invention, in which the exchange key has been inserted;

FIG. 4 is a cross-sectional view showing a lock structure of the present invention, in which the exchange key has been rotated;

FIG. 5 is an enlarged cross-sectional view taken along line A-A in FIG. 4;

FIG. 6 is a partial side cross-sectional view of the lock structure of the present invention, in which the exchange key has not yet been inserted, or an opening key has been already inserted; and

FIG. 7 is a partial side cross-sectional view of the lock structure of the present invention, in which the exchange key has been inserted and rotated.

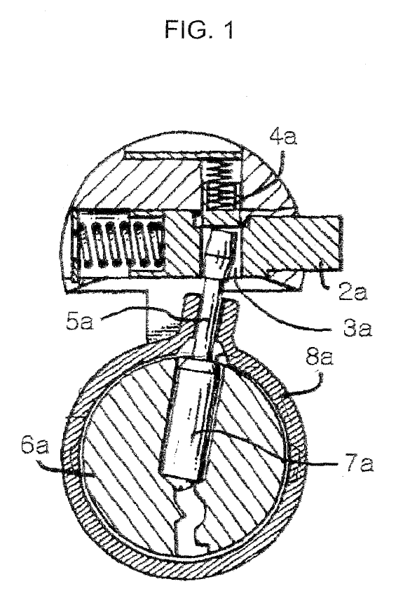

### DETAILED DESCRIPTION OF THE PREFERRED EMBODIMENT

Reference will now be made in detail to the preferred embodiment of the present invention in connection with the attached drawings.

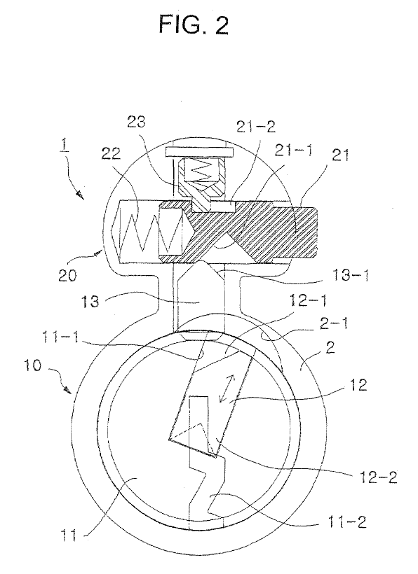

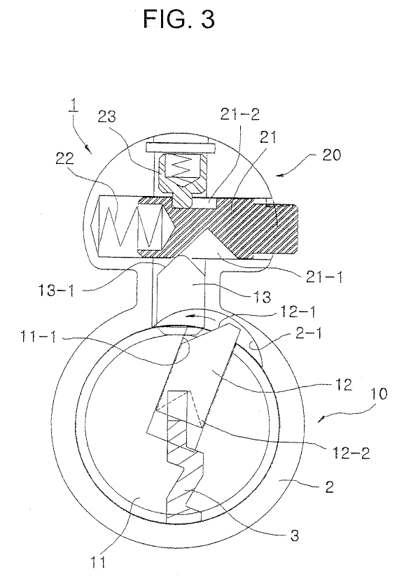

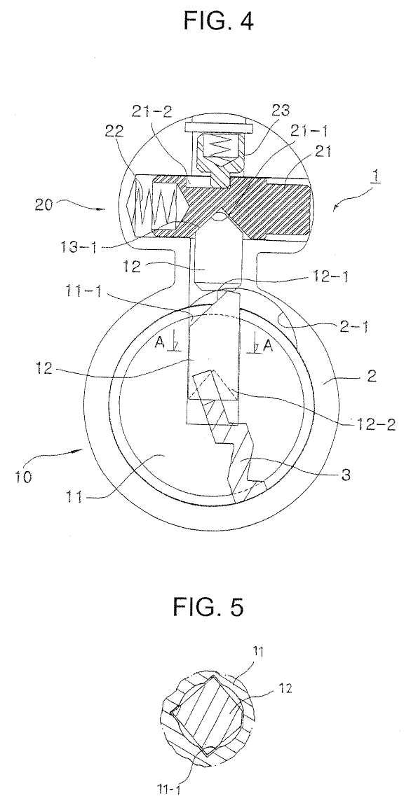

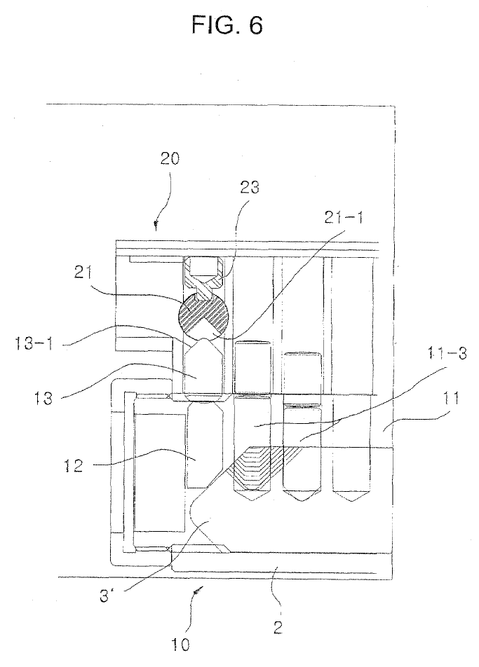

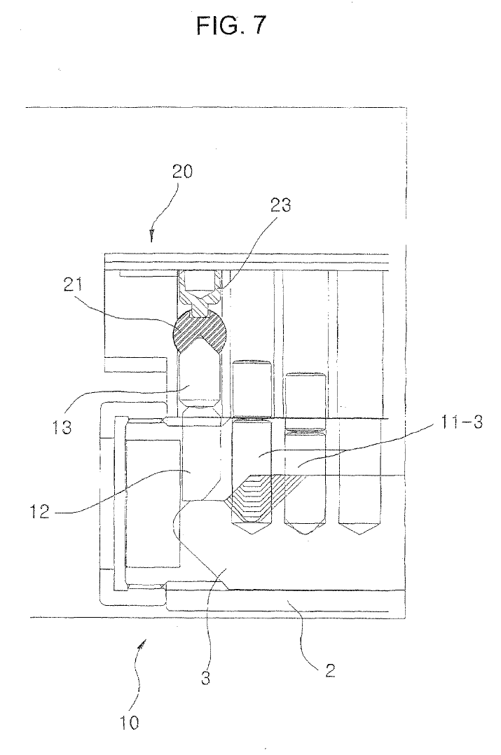

FIGS. 2 to 4 are cross-sectional views of the present invention, in which FIG. 2 shows a state prior to the insertion of the exchange key, FIG. 3 shows a state of the exchange key inserted, and FIG. 4 shows a state when the exchange key has been rotated. Also, FIG. 5 is an enlarged cross-sectional view taken along line A-A in FIG. 4, FIG. 6 is a partial side cross-sectional view of the lock structure of the present invention, in which the exchange key has not yet been inserted, or an opening key has been already inserted, and FIG. 7 is a partial side cross-sectional view of the lock structure of the present invention, in which the exchange key has been inserted and rotated.

The lock structure 1 of the present invention is provided with an opening and closing operation portion 10 at a lower portion of a main body for activating a rotary operation member 11 to thereby open and close a door lock by the insertion and rotation of a key, as was in the conventional general lock structure, and an exchange operation portion 20 provided with an operation slide 21 at an upper portion, the operation slide being projected at usual time, and the exchange operation portion is secured to a door lock main body and is activated only when the exchange key is inserted, to thereby enable the exchange.

In particular, the opening and closing operation portion 10 of the lock structure 1 according to the present invention, is provided with an operation pin 12 at innermost side of the rotary operation member 11 so that it functions to ascend and rotate the rotary operation member by the insertion of the exchange key 3 to thereby upwardly push an elevation pin 13, and is formed with an inclination surface 12-1 having an inclination angle at one side at an adjacent surface of the upper elevation pin 13, and is formed with an inclination portion 12-2 at lower end so that it is pushed upwardly by the insertion of the exchange key 3, and it is moved with the rotary operation member 11 after safely seated in an hole 11-1 formed at the rotary operation member 11, when the exchange key 3 is not inserted.

In addition, an operation space portion 2-1 is formed at the inside of the main body 2 adjacent to the upper end of the operation pin 12 so that the operation pin 12 acts to upwardly push the elevation pin 13 together with projecting and rotating of the upper end thereof when it is ascended.

The operation pin 12 and the hole 11-1 into which the operation pin 12 is inserted are formed to have an angled cross section so that they cannot rotate during the operation, and the operation pin is formed with the inclination surface 12-1 in the opposing diagonal direction, the angle of the inclination surface 12-1 being smooth and the length thereof extended to the maximum, so that it can be operated smooth.

The elevation pin 13 is provided at a connection portion between the opening and closing operation portion 10 and the exchange operation portion 20, so that lower end thereof is lowered till it contacts with the outer surface of the rotary operation member 11 and is maintained at the lowered state, and is pushed upwardly by the inclination surface 12-1 through the rotation of the operation pin 12 at the elevated state, and is formed with an inclination portion 13-1 at the upper end to activate the operation slide 21.

The operation slide 21 disposed on the upper portion of the elevation pin 13, i.e., at the exchange operation portion 20 is disposed in such a fashion that distal end thereof is projected to one side of the exchange operation portion 20 because one side of the operation slide is biased by a spring 22, to thereby be held to the main body of the door lock, and is provided with an inclination groove 21-1 at the bottom surface so that the operation slide 21 can move in the rearward direction together with producing frictions with the inclination portion 13-1 when the elevation pin 13 is ascended.

Moreover, a guide groove 21-2 is provided on the operation slide 21 so that a guide pin 23 can be inserted into the guide groove 21-2 to guide the rearward and forward movements and prevent the rotation.

Unexplained reference numeral 3′ denotes an opening and closing key, reference numeral 11-2 denotes a key hole, and reference numeral 11-3 denotes an opening and closing pin.

Hereinafter, the action of the exchangeable lock structure of the present invention will be described.

When the opening and closing key 3′ is inserted into the key hole 11-2 of the rotary operation member 11, as was in the general door lock with a basic exchangeable lock structure, the opening and closing pins 11-3 are arranged to allow the rotary operation member 11 to rotate, and when the opening and closing key 3′ is rotated, the rotary operation member 11 is rotated to activate the locking device of the door lock to thereby open the door.

Then, the exchange key 3 is required for separating the exchangeable lock structure 1, and since it is longer than the general opening and closing key, it can upwardly push the lower inclination portion 12-2 of the operation pin 12 by the end thereof.

Thus, when the operation pin 12 is ascended, the upper end becomes to be projected to the operation space portion 2-1. In this instance, if the exchange key 3 is rotated, the operation pin 12 is rotated together with the rotation pin 11 to thereby upwardly push the lower end of the elevation pin 13 by means of the upper inclination surface 12-1.

Since the upper inclination portion 13-1 is entered into the inclination groove 21-1 of the operation slide 21 in the course of the ascending of the elevation pin 13, the operation slide 21 enters into the inside of the exchange operation portion 20 completely together with the compression of the spring 22 in the course of the alignment of the inclination portion 13-1 with the inclination groove 21-1.

Thus, the operation slide 21 is released from the main body of the door lock by means of the procedure, so that the whole lock structure 1 can be separated from the main body of the door lock.

Then, the whole lock structure 1 is separated, and it is inserted into another door lock, and when the exchange key 3 is separated, it is returned to its original state to fix the lock structure. Then when the exchange key 3 is rotated in the reverse direction, the operation pin 12 is returned to its original position to thereby lower the elevation pin 13, and the operation slide 21 is returned by means of the force of the spring 22 to project to one side of the exchange operation portion 20 so that it is held to the main body of the door lock.

Accordingly, the present invention has advantages that it is possible to produce and supply the exchangeable lock structure at low production cost since the construction for exchanging the lock structure is very simple to thereby facilitate the production, the operation for exchange can be accurately and uniformly performed by the simple structure and operation, and it is convenient to use and easy to repair because there occurs no fault, and the like, so that the exchangeable lock structure of the present invention is highly improved in several respects and is a useful devise.

While the present invention has been described with reference to the particular illustrative embodiments, it is not to be restricted by the embodiments but only by the appended claims. Also, it is to be appreciated that those skilled in the art can change or modify the embodiments without departing from the scope and spirit of the present invention.

What is claimed is:

1. An exchangeable lock structure including an opening and closing portion 10 disposed at a lower portion of a main body 2 for opening and closing a door lock by the activation of a rotary operation member 11 using a key, and an exchange operation portion 20 disposed at an upper portion thereof and operated by an exchange key 3 for facilitating its exchange, wherein the exchangeable lock structure comprises;
an operation pin 12 having an inclination surface 12-1 formed at an upper end thereof, the inclination surface being formed with an inclination angle at one side, and an inclination portion 12-2 formed at a lower end thereof so that it is pushed upwardly by the insertion of the exchange key 3;
an operation space portion 2-1 formed at the inside surface of the main body 2 adjacent to an upper end of the operation pin 12 so that the upper end of the operation pin 12 is rotated at a projected state to thereby upwardly push an elevation pin 13;
the elevation pin 13 inserted into a connection portion between the opening and closing operation portion 10 and the exchange operation portion 20 so that it is ascended by the pushing of the inclination surface 12-1 when the operation pin 12 is rotated at an ascended state, the elevation pin being formed with an inclination portion 13-1 at the upper end thereof for activating an operation slide 21; and
the operation slide 21 disposed at an upper portion of the elevation pin 13, the operation slide being elastically supported at one side thereof by a spring 22 and being formed with an inclination groove 21-1 at a bottom surface thereof.

2. The exchangeable lock structure according to claim 1, wherein the operation pin 12 and a hole 11-1 into which the operation pin 12 is inserted, are formed to have an angled cross section and are formed with the inclination surface 12-1 in the opposing diagonal direction so that they are prevented from being rotated during the operation and an angle of the inclination surface 12-1 is smooth and the length of the inclination surface is lengthened to the maximum.

3. The exchangeable lock structure according to claim 1, further comprising a guide pin 23 for guiding the activation of the operation slide 21 along a guide groove 21-2 formed on a top surface thereof in the rearward and forward directions and preventing the rotation of the operation slide at a state where the guide pin is inserted in the guide groove.
